(19) United States
(12) Patent Application Publication
(10) Pub. No.: US 2021/0142940 A1
(43) Pub. Date: May 13, 2021

(54) Induction coil

(71) Applicant: Tsz Kin Ho, Hong Kong (CN)

(72) Inventor: Tsz Kin Ho, Hong Kong (CN)

(21) Appl. No.: 17/151,674

(22) Filed: Jan. 19, 2021

(51) Int. Cl. H01F 27/28; H01F 38/14

(52) U.S. Cl. CPC H01F 27/28; H01F 38/14

(57) ABSTRACT

An induction coil includes a first coil unit, a second coil unit, a third coil unit, a fourth coil unit, a fifth coil unit, a sixth coil unit, a seventh coil unit, an eighth coil unit, a ninth coil unit, a tenth coil unit, an eleventh coil unit and a twelfth coil unit all of which are arranged in a row. Each coil unit is a spring and comprises at least thirty coil bodies connected with each other and arranged in a stacked manner. The first, second, third, fourth, fifth, sixth, seventh and eighth coil units form a first coil module. The ninth, tenth, eleventh and twelfth coil units form a second coil module. The first coil module is connected with the second coil module. Therefore, when a magnet passes through the induction coil, the twelve coil units are simultaneously energized.

### BACKGROUND OF THE PRESENT INVENTION

### Field of Invention

The present invention relates to the field of induction coil technology, and more particularly to an induction coil for generators, AC/DC (alternating current/direct current) rectifiers, single, double, and ironless induction coil devices.

### Description of Related Arts

Induction coils are widely used in generators, AC/DC rectifiers and other facilities. However, the winding methods, shapes and specifications of the coils are different in different applications. Therefore, in some applications, if there are special requirements for the output current or the output voltage, the corresponding functions need. to be realized through the special induction coil.

### SUMMARY OF THE PRESENT INVENTION

In order to meet the specific requirements of different application scenarios, the present invention provides an induction coil.

The present invention adopts technical solutions as follows.

An induction coil comprises a first coil unit, a second coil unit, a third coil unit, a fourth coil unit, a fifth coil unit, a sixth coil unit, a seventh coil unit, an eighth coil unit, a ninth coil unit, a tenth coil unit, an eleventh coil unit and a twelfth coil unit all of which are arranged in a row, wherein:

each of the first coil unit, the second coil unit, the third coil unit, the fourth coil unit, the fifth coil unit, the sixth coil unit, the seventh coil unit, the eighth coil unit, the ninth coil unit, the tenth coil unit, the eleventh coil unit and the twelfth coil unit is a spring and comprises at least thirty coil bodies which are connected with each other and arranged in a stacked manner;

the first coil unit, the second coil unit, the third coil unit, the fourth coil unit, the fifth coil unit, the sixth coil unit, the seventh coil unit, and the eighth coil unit form a first coil module;

the ninth coil unit, the tenth coil unit, the eleventh coil unit and the twelfth coil unit form a second coil module;

the first coil module is connected with the second coil module, thereby when a magnet passes through the induction coil, the first, second, third, fourth, fifth, sixth, seventh, eighth, ninth, tenth, eleventh and twelfth coil units are simultaneously energized.

Preferably, in the first coil module, an output end of the first coil unit is connected with an input end of the third coil unit, an output end of the third coil unit is connected with an input end of the fifth coil unit, an output end of the fifth coil unit is connected with an input end of the seventh coil unit, an output end of the seventh coil unit is connected with an input end of the second coil unit, an output end of the second coil unit is connected with an input end of the fourth coil unit, an output end of the fourth coil unit is connected with an input end of the sixth coil unit, an output end of the sixth coil unit is connected with an input end of the eighth coil unit, an output end of the eighth coil unit is connected with an input end of the ninth coil unit.

Preferably, in the second coil module, an output end of the ninth coil unit is connected with an input end of the eleventh coil unit, an output end of the eleventh coil unit is connected with an input end of the tenth coil unit, an output end of the tenth coil unit is connected with an input end of the twelfth coil unit.

Beneficial effects of the present invention are as follows. Through the arrangement and the specific connection relationship of the twelve coil units, voltage will not be lost during power transmission. If a wire with a suitable quality and a diameter is used, for example, a wire with a diameter of 1.2 mm is able to support an output current of 3 A or more, and the current of 3 A is still remained after passing through the twelve coil units. Obviously, through the arrangement and the specific connection relationship of the twelve coil units, current keeps the loss to a minimum.

### BRIEF DESCRIPTION OF THE DRAWINGS

The drawing is a structurally schematic view of an induction coil provided by the present invention.

### DETAILED DESCRIPTION OF THE PREFERRED EMBODIMENT

In order to make those skilled in the art better understand the present invention better, the present invention will be further described in detail as below with reference to accompanying drawings.

As shown in the drawing, an induction coil according to a preferred embodiment of the present invention is illustrated, which comprises a first coil unit 1, a second coil unit 2, a third coil unit 3, a fourth coil unit 4, a fifth coil unit 5, a sixth coil unit 6, a seventh coil unit 7, an eighth coil unit 8, a ninth coil unit 9, a tenth coil unit 10, an eleventh coil unit 11 and a twelfth coil unit 12 all of which are arranged from left to right in a row, wherein: each of the first coil unit 1, the second coil unit 2, the third coil unit 3, the fourth coil unit 4, the fifth coil unit 5, the sixth coil unit 6, the seventh coil unit 7, the eighth coil unit 8, the ninth coil unit 9, the tenth coil unit 10, the eleventh coil unit 11 and the twelfth coil unit 12 is embodied to a spring and comprises at least thirty coil bodies 100 which are connected with each other and arranged in a stacked manner, namely, the induction coil comprises at least 360 coil bodies; the first coil unit 1, the second coil unit 2, the third coil unit 3, the fourth coil unit 4, the fifth coil unit 5, the sixth coil unit 6, the seventh coil unit 7, and the eighth coil unit 8 form a first coil module; the ninth coil unit 9, the tenth coil unit 10, the eleventh coil unit 11 and the twelfth coil unit 12 form a second coil module; the first coil module is connected with the second coil module, so that when a magnet passes through the induction coil, twelve coil units are energized at the same time.

The specific connection relationship among the above elements is described as follows.

In the first coil module, an output end of the first coil unit 1 is connected with an input end of the third coil unit 3, an output end of the third coil unit 3 is connected with an input end of the fifth coil unit 5, an output end of the fifth coil unit 5 is connected with an input end of the seventh coil unit 7, an output end of the seventh coil unit 7 is connected with an input end of the second coil unit 2, an output end of the second coil unit 2 is connected with an input end of the fourth coil unit 4, an output end of the fourth coil unit 4 is connected with an input end of the sixth coil unit 6, an output end of the sixth coil unit 6 is connected with an input end of the eighth coil unit 8, an output end of the eighth coil unit 8 is connected with an input end of the ninth coil unit 9.

In the second coil module, an output end of the ninth coil unit 9 is connected with an input end of the eleventh coil unit 11, an output end of the eleventh coil unit 11 is connected with an input end of the tenth coil unit 10, an output end of the tenth coil unit 10 is connected with an input end of the twelfth coil unit 12.

According the preferred embodiment of the present invention, an input end of the first coil unit 1 acts as an input end of the induction coil, and an output end of the twelfth coil unit 12 acts as an output end of the induction coil.

Also, the first coil unit 1, the second coil unit 2, the third coil unit 3, the fourth coil unit 4, the fifth coil unit 5, the sixth coil unit 6, the seventh coil unit 7, the eighth coil unit 8, the ninth coil unit 9, the tenth coil unit 10, the eleventh coil unit 11 and the twelfth coil unit 12 are able to be arranged from right to left in a row; accordingly, the specific connection relationship among the elements refers to the previous description.

The induction coil provided by the present invention is used with a carbon nano production machine, and the current released by the induction coil is able to effectively prepare carbon nano materials in nano products such as graphene or fullerene.

In the above description, it should be noted that the terms “connected” should be understood in a broad sense, for example, it is able to be a fixed connection, a detachable connection, or an integral connection; also, it is a direct connection, an indirect connection through an intermediate medium, or communication between an interior of two components.

Obviously, the preferred embodiments of the present invention are described above with the accompanying drawings, which are not intended to limit the protection scope of the present invention. Any modifications, equivalent substitutions and improvements made by those skilled in the art without departing from the scope and essence of the present invention should fall within the protection scope of the present invention.

What is claimed is:

1. An induction coil comprising a first coil unit, a second coil unit, a third coil unit, a fourth coil unit, a fifth coil unit, a sixth coil unit, a seventh coil unit, an eighth coil unit, a ninth coil unit, a tenth coil unit, an eleventh coil unit and a twelfth coil unit all of which are arranged in a row, wherein:
each of the first coil unit, the second coil unit, the third coil unit, the fourth coil unit, the fifth coil unit, the sixth coil unit, the seventh coil unit, the eighth coil unit, the ninth coil unit, the tenth coil unit, the eleventh coil unit and the twelfth coil unit is a spring and comprises at least thirty coil bodies which are connected with each other and arranged in a stacked manner;
the first coil unit, the second coil unit, the third coil unit, the fourth coil unit, the fifth coil unit, the sixth coil unit, the seventh coil unit, and the eighth coil unit form a first coil module;
the ninth coil unit, the tenth coil unit, the eleventh coil unit and the twelfth coil unit form a second coil module;
the first coil module is connected with the second coil module,
thereby when a magnet passes through the induction coil, the first, second, third, fourth, fifth, sixth, seventh, eighth, ninth, tenth, eleventh and twelfth coil units are simultaneously energized.

2. The induction coil according to claim 1, wherein in the first coil module, an output end of the first coil unit is connected with an input end of the third coil unit, an output end of the third coil unit is connected with an input end of the fifth coil unit, an output end of the fifth coil unit is connected with an input end of the seventh coil unit, an output end of the seventh coil unit is connected with an input end of the second coil unit, an output end of the second coil unit is connected with an input end of the fourth coil unit, an output end of the fourth coil unit is connected with an input end of the sixth coil unit, an output end of the sixth coil unit is connected with an input end of the eighth coil unit, an output end of the eighth coil unit is connected with an input end of the ninth coil unit.

3. The induction coil according to claim 1, wherein in the second coil module, an output end of the ninth coil unit is connected with an input end of the eleventh coil unit, an output end of the eleventh coil unit is connected with an input end of the tenth coil unit, an output end of the tenth coil unit is connected with an input end of the twelfth coil unit.
